(19) United States
(12) Patent Application Publication
(10) Pub. No.: US 2019/0331242 A1
(43) Pub. Date: Oct. 31, 2019

(54) EXPANSION SWITCH VALVE

(71) Applicant: BYD COMPANY LIMITED, Shenzhen (CN)

(72) Inventors: Xiaowei ZHANG, Shenzhen (CN); Jian HUANG, Shenzhen (CN); Xuefeng CHEN, Shenzhen (CN); Meijiao YE, Shenzhen (CN)

(73) Assignee: BYD COMPANY LIMITED, Shenzhen (CN)

(21) Appl. No.: 16/475,300

(22) PCT Filed: Dec. 21, 2017
(86) PCT No.: PCT/CN2017/117815

§ 371 Date: Jul. 1, 2019

(30) Foreign Application Priority Data
Dec. 29, 2016 (CN) 201611249731.5

(51) Int. Cl. F16K 11/20; F16K 27/02; F16K 31/06; F25B 41/06

(52) U.S. Cl. CPC F16K 11/20; F16K 27/0254; F25B 2341/065; F25B 41/062; F16K 31/0627

(57) ABSTRACT

An expansion switch valve includes a valve body, where an inlet, an outlet, and an internal passage in communication between the inlet and the outlet are formed on the valve body, a first valve plug and a second valve plug that are coaxial and are spaced apart from each other are mounted on the internal passage, the first valve plug makes the inlet and the outlet in direct communication or out of communication, and the second valve plug makes the inlet and the outlet in communication through a throttle hole or out of communication. In this way, an opening/closure control function or a throttle expansion control function can be implemented on a refrigerant by integrally mounting the first valve plug and the second valve plug that are coaxial and are spaced apart from each other on the internal passage of the same valve body. A structure is simple, and production and installation are easy.

### CROSS-REFERENCE TO RELATED APPLICATIONS

This application is the U.S. national phase entry of PCT Application No. PCT/CN2017/117815, filed Dec. 21, 2017, which claims priority to and benefits of Chinese Patent Application Serial No. 201611249731.5, filed with the State Intellectual Property Office of P. R. China on Dec. 29, 2016. The entire contents of the above-referenced applications are incorporated herein by reference.

### FIELD

This disclosure relates to the field of control valves, and specifically, to an expansion switch valve.

### BACKGROUND

In a heat pump system, sometimes, it is needed to control a refrigerant to be throttled and depressurized or to pass without being throttled, but existing electronic expansion valves can only control a refrigerant to be throttled or to not pass. To satisfy such a requirement of the heat pump system, a structure of connecting an electronic expansion valve and an electromagnetic switch valve in parallel needs to be used in the prior art. Two three-way joints and six pipelines need to be used in such a structure. Consequently, the structure is complex, and installation is inconvenient. When the electromagnetic valve is closed, and the electronic expansion valve is used, there is a moderate-temperature high-pressure liquid refrigerant at an inlet of the electronic expansion valve, and there is a low-temperature low-pressure liquid refrigerant at an outlet of the electronic expansion valve. Because the pipelines are in communication, statuses of refrigerants at an inlet and an outlet of the electromagnetic valve are also respectively the same as those at the inlet and the outlet of the electronic expansion valve. If pressures and temperatures of the refrigerants at the inlet and the outlet of the electromagnetic valve are different, it would be easy to cause damage to an internal structure of the electromagnetic valve. In addition, because of a relatively large quantity of pipelines, a filling amount of refrigerant of the entire heat pump system is increased, and costs are increased. When the heat pump system works at a low temperature, oil return of a compressor would be difficult, and such a complex structure is also disadvantageous to oil return of the heat pump system.

### SUMMARY

This disclosure provides an expansion switch valve, and the expansion switch valve is capable of implementing two functions, that is, opening/closure control and throttle control, on a medium that flows through the expansion switch valve, and has a simple structure.

To achieve the foregoing objective, this disclosure provides an expansion switch valve, including a valve body, where an inlet, an outlet, and an internal passage in communication between the inlet and the outlet are formed on the valve body, a first valve plug and a second valve plug that are coaxial and are spaced apart from each other are mounted on the internal passage, the first valve plug makes the inlet and the outlet in direct communication or out of communication, and the second valve plug makes the inlet and the outlet in communication through a throttle hole or out of communication.

By means of the foregoing technical solutions, an opening/closure control function or a throttle expansion control function can be implemented on a refrigerant by mounting the first valve plug and the second valve plug that are coaxial and are spaced apart from each other on the internal passage of the same valve body. A structure is simple, and production and installation are easy. In addition, when the expansion switch valve provided in this disclosure is applied to a heat pump system, pipeline connections are simplified, costs are reduced, a filling amount of refrigerant of the entire heat pump system is reduced, and oil return of a compressor is facilitated.

Other features and advantages of this disclosure are described in detail in the Detailed Description part below.

### BRIEF DESCRIPTION OF THE DRAWINGS

The accompanying drawing is used to further understand the disclosure and constitute a part of the specification, and is used to explain the disclosure together with the following specific implementations, but does not constitute a limitation on the disclosure. In the accompanying drawings:

FIG. 1 is a three-dimensional schematic structural view of an expansion switch valve along a direction according to an exemplary implementation of this disclosure;

FIG. 2 is a three-dimensional schematic structural view of an expansion switch valve along another direction according to an exemplary implementation of this disclosure;

FIG. 3 is a schematic sectional structural diagram of an expansion switch valve according to an exemplary implementation of this disclosure, where a first valve is port in a closed state, and a second valve port is in an open state; and

FIG. 4 is another schematic sectional structural diagram of an expansion switch valve according to an exemplary implementation of this disclosure, where a first valve is port in an open state, and a second valve port is in a closed state.

Reference numerals of the accompanying drawing:

| | | | | | |
|---|---|---|---|---|---|
| 500 | valve body | 501 | inlet | 502 | outlet |
| 503 | first valve plug | 513 | first valve stem | 523 | first plug |
| 504 | second valve plug | 514 | second valve stem | 505 | throttle hole |
| 506 | first passage | 16 | first valve port | 526 | first through-hole |
| 507 | second passage | 517 | second valve port | 527 | second through-hole |
| 510 | valve base | 511 | first valve housing | 521 | first electromagnetic |
| 512 | second valve housing | 522 | second electromagnetic | | drive portion |
| | | | drive portion | | |

### DETAILED DESCRIPTION

Specific implementations of this disclosure are described in detail below with reference to the accompanying drawings. It should be understood that the specific implementations described herein are merely used to describe and explain this disclosure rather than limit this disclosure.

In this disclosure, unless contrarily described, the used locality terms, such as “up, down, left, and right”, are usually relative to graphical directions of the accompanying drawings. “Upstream and downstream” are relative to a flowing direction of a medium such as a refrigerant. Specifically, being in a direction the same as a flowing direction of the refrigerant is being downstream, and being in a direction opposite to the flowing direction of the refrigerant is being upstream. “Inside and outside” indicate being inside and outside a contour of a component.

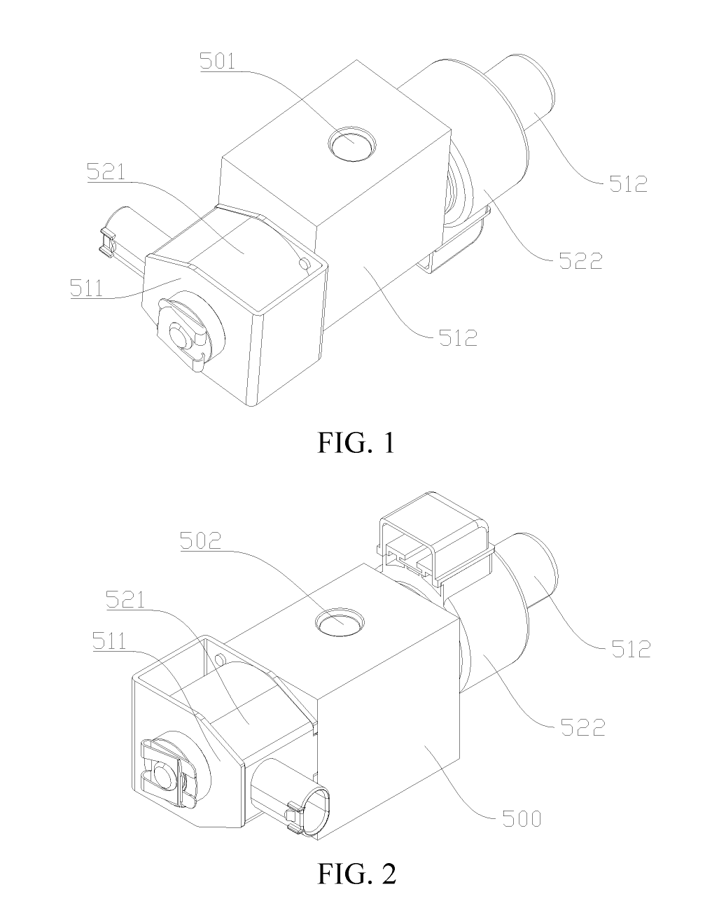

As shown in FIG. 1 to FIG. 4, an expansion switch valve provided in this disclosure includes a valve body 500, where an inlet 501, an outlet 502, and an internal passage in communication between the inlet 501 and the outlet 502 are formed on the valve body 500, a first valve plug 503 and a second valve plug 504 that are coaxial and are spaced apart from each other are mounted on the internal passage, the first valve plug 503 makes the inlet 501 and the outlet 502 in direct communication or out of communication, and the second valve plug 504 makes the inlet 501 and the outlet 502 in communication through a throttle hole 505 or out of communication.

The “direct communication” implemented by the first valve plug 503 means that a refrigerant entered from the inlet 501 of the valve body 500 can bypass the first valve plug 503 and directly flow to the outlet 502 of the valve body 500 through the internal passage without being throttled, and the “out of communication” implemented by the first valve plug 503 means that the refrigerant entered from the inlet 501 of the valve body 500 cannot bypass the first valve plug 503 and cannot flow to the outlet 502 of the valve body 500 through the internal passage. The “communication through a throttle hole” implemented by the second valve plug 504 means that the refrigerant entered from the inlet 501 of the valve body 500 can bypass the second valve plug 504 and flow to the outlet 502 of the valve body 500 after being throttled by a throttle hole, and the “out of communication” implemented by the second valve plug means that the refrigerant entered from the inlet 501 of the valve body 500 cannot bypass the second valve plug 504 and cannot flow to the outlet 502 of the valve body 500 through the throttle hole 505.

In other words, the expansion switch valve has at least a first operating location, a second operating location, and a third operating location. When the expansion switch valve is at the first operating location, the first valve plug 503 makes the inlet 501 and the outlet 502 in direct communication, and the second valve plug 504 makes the inlet 501 and the outlet 502 out of communication. When the expansion switch valve is at the second operating location, the first valve plug 503 makes the inlet 501 and the outlet 502 out of communication, and the second valve plug 504 makes the inlet 501 and the outlet 502 in communication through the throttle hole 505. When the expansion switch valve is at the third operating location, the first valve plug 503 makes the inlet 501 and the outlet 502 out of communication, and the second valve plug 504 makes the inlet 501 and the outlet 502 out of communication.

In this way, the expansion switch valve in this disclosure can achieve at least three states of the refrigerant entered from the inlet 501 by controlling the first valve plug 503 and the second valve plug 504: (1) a closed state; (2) a direct communication state by bypassing the first valve plug 503; and (3) a throttled communication manner by bypassing the second valve plug 504.

After being throttled by the throttle hole 505, a high-temperature high-pressure liquid refrigerant may become a low-temperature low-pressure atomized liquid refrigerant. This creates a condition for evaporation of the refrigerant. That is, a cross sectional area of the throttle hole 505 is smaller than respective cross sectional areas of the inlet 501 and the outlet 502, and an opening degree of the throttle hole 505 may be adjusted by controlling the second valve plug 504, to control an amount of flow passing through the throttle hole 505, thereby avoiding insufficient refrigeration caused by an excessively small amount of refrigerant and avoiding a liquid slugging phenomenon in the compressor that is caused by an excessively large amount of refrigerant. That is, cooperation between the second valve plug 504 and the valve body 500 can make the expansion switch valve have the expansion valve function.

In this way, an opening/closure control function or a throttle control function between the inlet 501 and the outlet 502 can be implemented by mounting the first valve plug 503 and the second valve plug 504 that are coaxial and are spaced apart from each other on the internal passage of the same valve body 500. A structure is simple, and production and installation are easy. In addition, when the expansion switch valve provided in this disclosure is applied to a heat pump system, pipeline connections are simplified, a filling amount of refrigerant of the entire heat pump system is reduced, costs are reduced, and oil return of the heat pump system is facilitated.

As an exemplary internal installation structure of the valve body 500, as shown in FIG. 1 to FIG. 4, the valve body 500 includes a valve base 510 that forms an internal passage and a first valve housing 511 and a second valve housing 512 that are mounted on the valve base 510. A first electromagnetic drive portion 521 used for driving the first valve plug 503 is mounted in the first valve housing 511, and a second electromagnetic drive portion 522 used for driving the second valve plug 504 is mounted in the second valve plug 504. The first valve plug 503 extends from the valve housing 511 to the internal passage inside the valve base 510, and the second valve plug 504 extends from the second valve housing 512 to the internal passage inside the valve base 510.

A location of the first valve plug 503 in the internal passage can be easily controlled by controlling power-on or power-off of the first electromagnetic drive portion 521 (for example, an electromagnetic coil), to control direct-communication or out-of-communication between the inlet 501 and the outlet 502. A location of the second valve plug 504 in the internal passage can be easily controlled by controlling power-on or power-off of the second electromagnetic drive portion 522 (for example, an electromagnetic coil), to control whether the inlet 501 and the outlet 502 are in communication with the throttle hole 505. In other words, it may be understood that an electronic expansion valve and an electromagnetic valve that share the inlet 501 and the outlet 502 are connected in parallel and mounted integrally in the valve body 500. Therefore, automated control on opening/closure or throttling of the expansion switch valve can be implemented, and pipeline arrangement can be simplified.

To fully use spatial locations of the expansion switch valve in different directions and avoid connections between the expansion switch valve and different pipelines from interfering with each other, the valve base 510 is of a polyhedral structure, the first valve housing 511, the second valve housing 512, the inlet 501, and the outlet 502 are respectively disposed on different surfaces of the polyhedral structure, installation directions of the first valve housing 511 and the second valve housing 512 are parallel to each other, and opening directions of the inlet 501 and the outlet 502 are parallel to each other. In this way, inlet and outlet pipelines can be connected to the different surfaces of the polyhedral structure, thereby avoiding a problem of disordered and twisted pipeline arrangement.

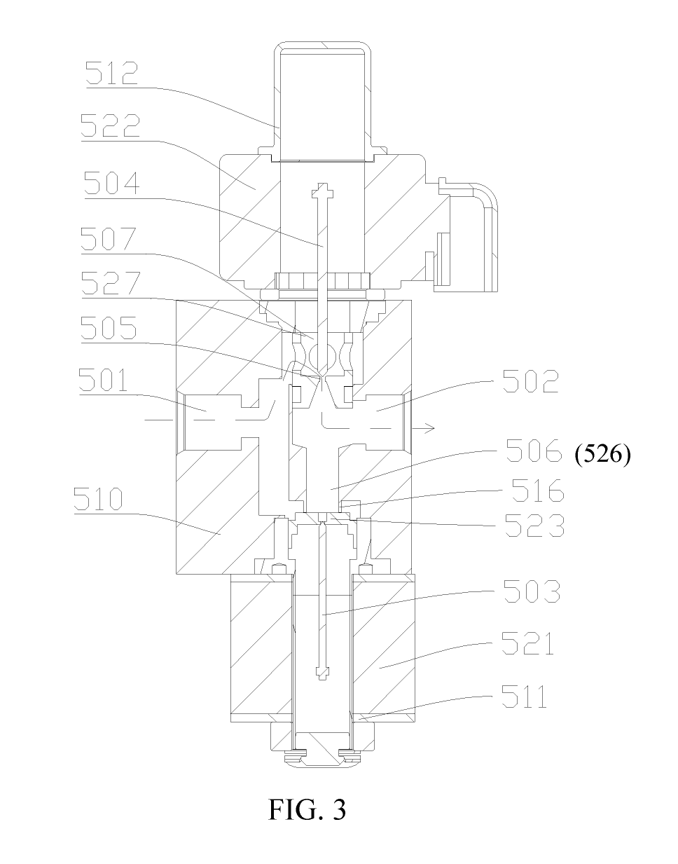

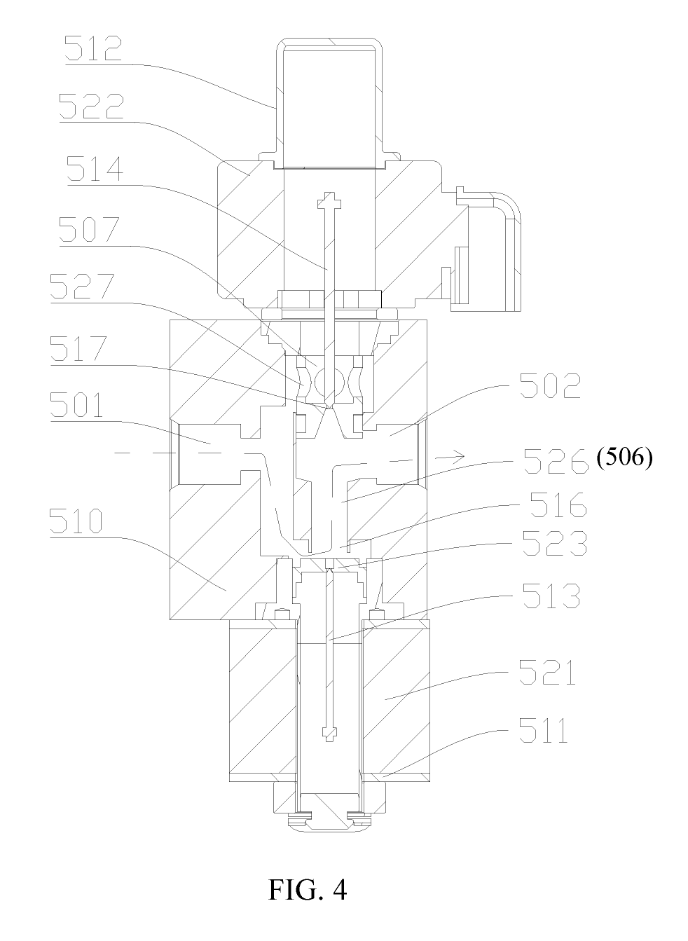

As shown in FIG. 3 and FIG. 4, the internal passage includes a first passage 506 and a second passage 507 that are separately in communication with the inlet 501, a first valve port 516 fitting the first valve plug 503 is formed on the first passage 506, the throttle hole 505 is formed on the second passage 507 to form a second valve port 517 fitting the second valve plug 504, and the first passage 506 and the second passage 507 converge at downstream of the second valve port 517 and are in communication with the outlet 502.

That is, the first valve port 516 is closed or opened by changing the location of the first valve plug 503 in the internal passage, to control closure or opening of the first passage 506 in communication between the inlet 501 and the outlet 502, thereby implementing the opening or closure function of the electromagnetic valve described above. Similarly, the second valve port 517 is open or closed by changing the location of the second valve plug 504 in the internal passage, thereby implementing the throttle function of the electronic expansion valve.

The first passage 506 and the second passage 507 can be respectively in communication with the inlet 501 and the outlet 502 in any suitable arrangement manner. To reduce an overall occupied space of the valve body 500, as shown in FIG. 3 and FIG. 4, the second passage 507 and the outlet 502 are perpendicular to each other, the first passage 506 is formed as a first through-hole 526 that is coaxial with and is spaced apart from the second passage 507, the inlet 501 is in communication with the second passage 507 through a second through-hole 527 provided on a sidewall of the second passage 507, and the first through-hole 526 and the second through-hole 527 are separately in communication with the inlet 501.

The first valve plug 503 and the second valve plug 504 may be disposed in opposite directions. To make the structure of the valve body 500 compact, as shown in FIG. 3 and FIG. 4, the first valve plug 503 and the second valve plug 504 are disposed opposite to each other. That is, the first valve port 516 and the second valve port 517 are both located between the first valve plug 503 and the second valve plug 504. In this way, the size of the valve body 500 along an axial direction parallel to the first valve plug 503 can be reduced, thereby reducing an overall occupied space of the valve body 500.

In order that the inlet and the outlet of the valve body 500 are easily respectively connected to pipe connectors of different pipelines, as shown in FIG. 1 to FIG. 4, the inlet 501 and the outlet 502 are coaxially provided on two opposite sides of the valve body 500. In this way, the pipe connectors of the different pipelines may be respectively mounted to two opposite sides of the valve body 500, to avoid a limitation on a mounting space on a same side of the valve body, and prevent the different pipelines from being arranged in a mess and in a tangle.

As shown in FIG. 3 and FIG. 4, to easily close and open the first valve port 516, the first valve plug 503 is disposed coaxially with the first valve port 516 along a moving direction, to selectively plug up or detach from the first valve port 516.

To easily close and open the second valve port 517, as shown in FIG. 3 and FIG. 4, the second valve plug 504 is disposed coaxially with the second valve port 517 along a moving direction, to selectively plug up or detach from the second valve port 517.

Further, as shown in FIG. 4, to ensure reliability of plugging up the first passage 506 by using the first valve plug 503, the first valve plug 503 may include a first valve stem 513 and a first plug 523 connected to an end portion of the first valve stem 513, and the first plug 523 is used for pressing against an end face of the first valve port 516 in a sealing manner to plug up the first passage 506.

To easily adjust the opening degree of the throttle hole 505 of the expansion switch valve, as shown in FIG. 4, the second valve plug 504 includes a second valve stem 514, an end portion of the second valve stem 514 is formed as a conical head structure, and the second valve port 517 is formed as a conical hole structure fitting the conical head structure.

The opening degree of the throttle hole 505 of the expansion switch valve may be adjusted by moving the second valve plug 504 upward and downward, and the upward and downward moving of the second valve plug 504 may be adjusted by using the second electromagnetic drive portion 522. If the opening degree of the throttle hole 505 of the expansion switch valve is zero, as shown in FIG. 4, the second valve plug 504 is located at a lowest location, the second valve plug 504 plugs up the second valve port 517, and none of the refrigerant can pass through the throttle hole 505. If the throttle hole 505 of the expansion switch valve has an opening degree, as shown in FIG. 3, there is a gap between the conical head structure of the end portion of the second valve plug 504 and the throttle hole 505, and the refrigerant flows to the outlet 502 after being throttled. If the opening degree of the throttle hole 505 of the expansion switch valve needs to be increased, the second electromagnetic drive portion 522 may be controlled to move the second valve plug 504 upward, to make the conical head structure depart from the throttle hole 505, so that the opening degree of the throttle hole 505 is increased. In contrast, when the opening degree of the throttle hole 505 of the expansion switch valve needs to be decreased, the second valve plug 504 is driven to move downward.

During use, when only a direct communication function of the expansion switch valve needs to be used, that is, when the expansion switch valve is located at the foregoing first operating location, as shown in FIG. 4, the first electromagnetic drive portion 521 is powered off, the first plug 523 of the first valve plug 503 detaches from the first valve port 516, and the first valve port 516 is in an open state; and the second electromagnetic drive portion 522 is powered on, the second valve plug 504 is located at the lowest location, the second valve plug 504 plugs up the throttle hole 505, and the refrigerant flowing from the inlet 501 into the internal passage completely cannot pass through the throttle hole 505, and can only flow into the outlet 502 sequentially through the first valve port 516 and the first through-hole 526.

It should be noted that in FIG. 4, a dashed line with an arrow indicates a flowing route and a direction of the refrigerant when the direct communication function is used.

When only a throttled communication function of the expansion switch valve needs to be used, that is, when the expansion switch valve is located at the foregoing second operating location, as shown in FIG. 3, the first electromagnetic drive portion 521 is powered on, the first plug 523 of the first valve plug 503 plugs up the first valve port 516, and the first valve port 516 is in a closed state; and the second electromagnetic drive portion 522 is powered off, the second valve plug 504 is located at the highest location, the second valve plug 504 detaches from the throttle hole 505, the refrigerant flowing from the inlet 501 into the internal passage completely cannot pass through the first through-hole 526 and can only flow into the outlet 502 sequentially through the second through-hole 527 and the throttle hole 505, and the second valve plug 504 may be moved upward and downward to adjust the opening degree of the throttle hole 505.

It should be noted that in FIG. 3, a dashed line with an arrow indicates a flowing route and a direction of the refrigerant when the throttled communication function is used.

When neither the direct communication function nor the throttled communication function of the expansion switch valve needs to be used, that is, when the expansion switch valve is located at the foregoing third operating location, the first electromagnetic drive portion 521 is powered on, the first plug 523 of the first valve plug 503 plugs up the first valve port 516, and the first valve port 516 is in a closed state; and the second electromagnetic drive portion 522 is powered on, the second valve plug 504 is located at the lowest location, the second valve plug 504 plugs up the throttle hole 505, and the refrigerant flowing from the inlet 501 into the internal passage completely cannot pass through the first passage and the second passage, that is, the internal passage is in a closed state.

Although preferred implementations of this disclosure are described in detail above with reference to the accompanying drawings, this disclosure is not limited to specific details in the foregoing implementations. Various simple variations can be made to the technical solutions of this disclosure within the scope of the technical idea of the present invention, and such simple variations all fall within the protection scope of this disclosure.

It should be further noted that the specific technical features described in the foregoing specific implementations can be combined in any appropriate manner provided that no conflict occurs. To avoid unnecessary repetition, various possible combination manners will not be described in the present invention.

Moreover, various different implementations of the disclosure may also be randomly combined with each other. Provided that the combination does not depart from the idea of the disclosure, the combination should be similarly considered as the content disclosed in the disclosure.

What is claimed is:

1. An expansion switch valve, comprising a valve body, having an inlet, an outlet, and an internal passage substantially between the inlet and the outlet, a first valve plug and a second valve plug coaxial with [LY1] and spaced apart from each other and on the internal passage, wherein the first valve plug controls direct communication between the inlet and outlet and the second valve plug controls communication between the inlet and the outlet through a throttle hole.

2. The expansion switch valve according to claim 1 further comprising a first passage and a second passage in the internal passage [LY2], wherein the first passage and second passage are separately connected with the inlet, a first valve port formed on the first passage and fitting the first valve plug, the throttle hole is formed on the second passage to comprise a second valve port [LY3] fitting the second valve plug, and wherein the first passage and the second passage converge downstream of the second valve port and are connected with the outlet.

3. The expansion switch valve according to claim 2, wherein the second passage and the outlet are substantially perpendicular to each other, the first passage is formed as a first through-hole that is coaxial with and is spaced apart from the second passage, the inlet connected with the second passage, through a second through-hole provided on a side wall of the second passage, the first through-hole and the second through-hole are separately connected with the inlet, and the first valve port and the second valve port are both between the first valve plug and the second valve plug.

4. The expansion switch valve according to claim 1, wherein the inlet and the outlet are coaxially provided on two opposite sides of the valve body.

5. The expansion switch valve according to claim 2, wherein the first valve plug is arranged coaxially with the first valve port along a movement direction to selectively plug up or detach from the first valve port.

6. The expansion switch valve according to claim 2, wherein the second valve plug is arranged coaxially with the second valve port along a movement direction to selectively plug up or detach from the second valve port.

7. The expansion switch valve according to claim 5, wherein the first valve plug comprises a first valve stem and a first plug connected to an end portion of the first valve stem, and the first plug is used for pressing against an end face of the first valve port in a sealing manner to plug up the first passage.

8. The expansion switch valve according to claim 6, wherein the second valve plug comprises a second valve stem, an end portion of the second valve stem is formed as a conical head structure, and the second valve port is formed as a conical hole structure fitting the conical head structure.

9. The expansion switch valve according to claim 1, wherein the valve body comprises a valve base that forms the internal passage and a first valve housing and a second valve housing mounted on the valve base, a first electromagnetic drive portion used for driving the first valve plug is mounted inside the first valve housing, a second electromagnetic drive portion used for driving the second valve plug is mounted inside the second valve housing, the first valve plug extends from the first valve housing to the internal passage inside the valve base, and the second valve plug extends from the second valve housing to the internal passage inside the valve base.

10. The expansion switch valve according to claim 9, wherein the valve base is formed as a polyhedral structure, and the first valve housing, the second valve housing, the inlet, and the outlet are separately disposed on different surfaces of the polyhedral structure, wherein installation directions of the first valve housing and the second valve housing are parallel to each other, and opening directions of the inlet and the outlet are parallel to each other.

11. The expansion switch valve according to claim 3, wherein the inlet and the outlet are coaxially provided on two opposite sides of the valve body.

12. The expansion switch valve according to claim 3, wherein the first valve plug is arranged coaxially with the first valve port along a movement direction to selectively plug up or detach from the first valve port.

13. The expansion switch valve according to claim 11, wherein the second valve plug is arranged coaxially with the second valve port along a movement direction to selectively plug up or detach from the second valve port.

14. The expansion switch valve according to claim 12, wherein the second valve plug is arranged coaxially with the second valve port along a movement direction to selectively plug up or detach from the second valve port.

15. The expansion switch valve according to claim 12, wherein the first valve plug comprises a first valve stem and a first plug connected to an end portion of the first valve stem, and the first plug is used for pressing against an end face of the first valve port in a sealing manner to plug up the first passage.

16. The expansion switch valve according to claim 14, wherein the second valve plug comprises a second valve stem, an end portion of the second valve stem is formed as a conical head structure, and the second valve port is formed as a conical hole structure fitting the conical head structure.

17. The expansion switch valve according to claim 16, wherein the valve body comprises a valve base that forms the internal passage and a first valve housing and a second valve housing mounted on the valve base, a first electromagnetic drive portion used for driving the first valve plug is mounted inside the first valve housing, a second electromagnetic drive portion used for driving the second valve plug is mounted inside the second valve housing, the first valve plug extends from the first valve housing to the internal passage inside the valve base, and the second valve plug extends from the second valve housing to the internal passage inside the valve base.

18. The expansion switch valve according to claim 17, wherein the valve base is formed as a polyhedral structure, and the first valve housing, the second valve housing, the inlet, and the outlet are separately disposed on different surfaces of the polyhedral structure, wherein installation directions of the first valve housing and the second valve housing are parallel to each other, and opening directions of the inlet and the outlet are parallel to each other.

19. An expansion switch valve, comprising a valve body, having an inlet, an outlet, and an internal passage substantially between the inlet and the outlet, a first valve plug and a second valve plug coaxial to and spaced apart from each other and on the internal passage, wherein the first valve plug controls direct communication between the inlet and outlet and the second valve plug controls communication between the inlet and the outlet through a throttle hole, wherein the valve body comprises a valve base that forms the internal passage and a first valve housing and a second valve housing mounted on the valve base, the first valve plug extends from the first valve housing to the internal passage inside the valve base, and the second valve plug extends from the second valve housing to the internal passage inside the valve base.

20. The expansion switch valve according to claim 19, wherein the valve base is formed as a polyhedral structure, and the first valve housing, the second valve housing, the inlet, and the outlet are separately disposed on different surfaces of the polyhedral structure, wherein installation directions of the first valve housing and the second valve housing are parallel to each other, and opening directions of the inlet and the outlet are parallel to each other.
